(19) United States
(12) Patent Application Publication
(10) Pub. No.: US 2013/0290052 A1
(43) Pub. Date: Oct. 31, 2013

(54) METHODS AND SYSTEMS FOR MANAGING RENOVATION OF A PROPERTY

(71) Applicant: Frank SETTINO, Concord (CA)

(72) Inventor: Frank SETTINO, Concord (CA)

(21) Appl. No.: 13/459,689

(22) Filed: Apr. 30, 2012

(51) Int. Cl. G06Q 10/06; G06Q 50/16

(52) U.S. Cl. 705/7.15

(57) ABSTRACT

Methods and systems for managing renovation of a property. Upon receiving signals representing instructions to carry out a renovation task for the property, a policy database is queried to determine an applicable policy based on the received instructions, and the renovation task is identified based on the received instructions and/or the applicable policy. A schedule is generated for the renovation task, by identifying a preferred time period for carrying out at least a portion of the renovation task, based on the applicable policy, and prioritizing performance of at least that portion during the preferred time period. An interface is provided for updating status of completion of the renovation task. A report of the renovation task is generated.

### TECHNICAL FIELD

The present disclosure relates generally to methods and systems for managing renovation of a property.

### BACKGROUND

Renovation work on a property generally results in a loss of access to some or all of the area being renovated. For rental property, this may result in a loss of income for the unrented period. For non-rental property there is still a potential loss or diminution of usability during renovation activities. There is, therefore, an incentive to reduce this “down time”. There is an additional incentive to make the duration predictable, so others can plan around it.

Historically, management of interior renovation has been left to busy people who are not interior renovation specialists—superintendents and facilities managers. This is efficient when all that is needed is a paint job and minor maintenance.

As buildings age, profit margins tighten, government regulation increases and ownership of real property moves more into the hands of publicly traded companies, the pressure is on to incorporate more varied and more complex work into the renovation cycle, to get more life and more income out of each building, and to provide transparency, accountability and justifiability into the business process.

In the current real estate market, most buildings may have aged, and more components may be failing. Unit turnover may thus require substantially more work than previously. More work may require more trades, more interactions and interlocking requirements. This makes work sequencing and scheduling more complex, and results in inefficiencies.

Furthermore, most properties may be owned by large conglomerates with hundreds of properties and tens of thousands of units in their portfolios. They may be publicly traded and report regularly to shareholders. They may be required by the marketplace and by the shareholders, to be accountable for costs.

As well, properties may now compete with a vast array of other housing options. With low interest rates, some renters may have fled to home ownership. Condos, both rental condos and self-owned condos, may be another competitor in the same marketplace. Townhouses may have lowered the real property component of home ownership, providing more competition for apartments. All of these pressures may have made the rental unit market much more competitive than ever before.

As a result, demands on property managers may be higher than before. Where once it may have been sufficient to just get the renovation work done, managing an apartment building or portfolio may be a much more complex exercise than it was previously. Portfolio managers may require better information, better tools and/or better decision support systems.

The business process that was historically viewed as adequate for renovation work is now seen as inefficient from both a time and money perspective. It is also highly variable in duration.

The business process for renovation work is typically initiated by a request from a client. The request can be communicated in many forms such as phone, email, fax or personal communication. In general there are four basic types of requests: request for work that is time and material based where the client knows the scope of the work and contains the authority to proceed; a request for work where a price list is involved and the client knows the scope and contains the authority to proceed; a request to quote where the client knows the scope but must wait for the RFQ response and then authority to proceed; and finally a request to document the requirement and quote where the client does not know the scope of the work to be done and must wait for the RFQ response and then authority to proceed.

Referring to FIG. 4, where the request for renovation is for a residential renovation, the steps and associated timing typically goes as follows. The first phase is the pre move out phase where the tenant notifies of the client/landlord of their intent to move out. The partial scope of the work is assessed by client where possible. Any charge-backs to the tenant due to damage etc. may be identified here. The tenant may then move out at which point rent stops for the client.

The next phase is the vacancy phase where the scope of the renovation work is finalized, created and quoted on by one to several contractors. Quotes are provided and either accepted or rejected, after which authorizations are give to proceed and the work may begin.

Once the renovation work begins there may be construction delays that require rescheduling which results in additional work. Once the requested work is completed the work is inspected to ensure the quality and determine if any rework needs to be assigned. Once approved the renovation is completed and the unit may be re-rented and rental income commences.

Where the request for renovation work is non-residential renovation, the steps and associated timing goes as follows. The required renovation work is identified, the scope is created and quoted on by one to several contractors. Once the quotes are accepted and authorization is given to proceed, the renovation work begins.

Given that non-residential renovation may be in a common area this may result in partial or complete restriction to traffic in the area. Once construction begins there may be construction delays that can cause rescheduling and additional construction. Once the work is complete, the quality is inspected to determine if any additional rework is required, and then the renovation is complete and any space usage restrictions may be lifted.

### SUMMARY

The disclosed systems and methods may be suitable for managing renovation tasks or renovation work.

Different types of renovation work may differ in various ways, and may be subject to various restrictions on work, such as: acceptable hours of work, notice period required before work can be performed, degree of service restoration at end-of-day, etc. Such restrictions might stem from legislation, from landlord preferences, from tenant preferences and/or any combination of the above. For example, in turnover work, there may be restrictions about visiting the unit during the pre-move-out period, but none during the vacant period. For service work, notice to the tenant may be required for each visit necessary for the renovation (e.g., inspection, repair).

In addition, certain services may need to be restored each night (e.g., hot and cold water, electricity, etc). For common area work, the building management may impose restrictions on the renovation (e.g., cleanup required at end of work day, work time-of-day limits, etc.).

In some aspects there is provided a method, carried out by one or more processors, for managing renovation of a property, the method including: upon receiving signals representing instructions to carry out one or more renovation tasks for the property; querying a policy database to determine at least one applicable policy based on the received instructions and identifying one or more renovation tasks based on at least one of the received instructions and the at least one applicable policy; generating a schedule for the one or more renovation tasks, wherein generating the schedule comprises identifying at least one preferred time period for carrying out at least a portion of the one or more renovation tasks, based on the at least one policy, and prioritizing performance of at least the portion of the one or more renovation tasks during the preferred time period; presenting an interface for updating status of completion of the one or more renovation tasks; and generating a report of the one or more renovation tasks.

The at least one applicable policy may be determined based on at least one of: information identifying the property, information identifying the one or more renovation tasks and at least one other applicable policy.

At least one of the one or more renovation tasks may include a plurality of interrelated components, and at least one of the components may be prioritized to be performed during the preferred time period over at least one other component. At least one of the components may be restricted to be performed outside of the preferred time period.

At least one of the one or more renovation tasks may include at least one dependent component dependent on completion of at least one prerequisite component, and the at least one prerequisite component may be prioritized in the schedule over the at least one dependent component.

The method may further include: determining at least one personnel for carrying out at least a portion of at least one renovation task, the determination being based on a query of a personnel database storing information about one or more personnel; and updating the status of completion of the respective renovation task using information received, via the interface, from the at least one personnel.

The method may further include: detecting, using the information received from the at least one personnel, a deviation from the schedule; generating a notification indicating the deviation; and providing the generated notification to at least the same or another personnel via the interface.

The method may further include: detecting, using the information received from the at least one personnel, a deviation from the schedule; and modifying the schedule to accommodate the deviation while maintaining the priority of any prioritized portions of the one or more renovation tasks.

The preferred time period may be at least one of: a period associated with lower activity in the property, a period associated with lower costs, a period associated with greater availability of personnel and a period associated with less inconvenience in the property.

The method may further include generating one or more logs tracking completion of the one or more renovation tasks.

In some aspects, the present disclosure provides a system for managing renovation of a property, the system including: a memory accessible by a processor, the memory comprising: at least one policy database storing one or more predefined policies for carrying out renovation tasks; the processor configured to implement a task management module, the task management module, when executed, causing the processor to: upon receiving signals representing instructions to carry out one or more renovation tasks for the property: query the policy database to determine at least one applicable policy based on the received instructions and identifying one or more renovation tasks based on at least one of the received instructions and the at least one applicable policy; generate a schedule for the one or more renovation tasks, wherein generating the schedule comprises identifying at least one preferred time period for carrying out at least a portion of the one or more renovation tasks, based on the at least one policy, and prioritizing performance of at least the portion of the one or more renovation tasks during the preferred time period; the processor configured to implement an interface module, the interface module, when executed, causing the processor to: provide as output the generated schedule; present an interface for receiving status updates of completion of the one or more renovation tasks; and provide as output a generated report of the one or more renovation tasks.

The memory may further include at least one of: a property database storing information about one or more properties available for renovation; a personnel database storing information about one or more personnel for performing the one or more renovation tasks; a report database storing one or more generated reports; and a deviation database storing information about one or more deviations from any generated schedule.

The task management module may further cause the processor to automatically update at least one policy stored in the policy database based on historical data.

At least one of the interface and the output may be accessible by an external device. The external device may be one of: a desktop device, a handheld device, a tablet device, a wired device and a wireless device.

### BRIEF DESCRIPTION OF THE DRAWINGS

Reference will now be made to the drawings, which show by way of example embodiments of the present disclosure, and in which:

FIG. 1 shows a flowchart illustrating an example method for managing renovation of a property;

FIG. 2 shows a schematic illustrating an example system for managing renovation of a property;

FIG. 3 shows a flowchart illustrating implementation of an example method for managing renovation of a property, for turnover work; and

FIG. 4 shows a flowchart illustrating an example of a conventional renovation process.

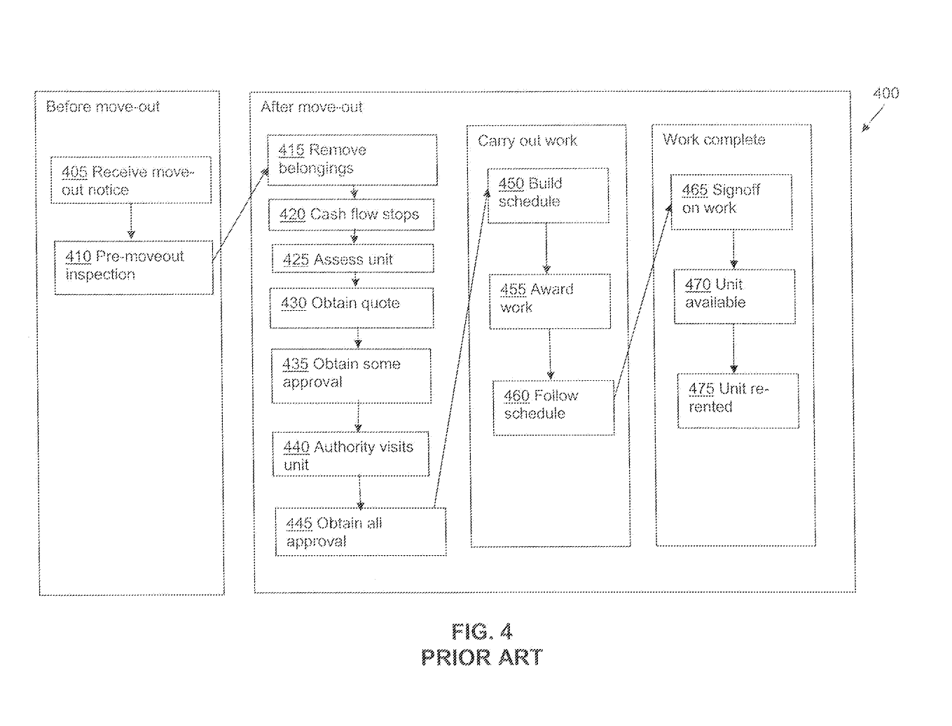

It will be noted that throughout the appended drawings, like features are identified by like reference numerals.

### DETAILED DESCRIPTION

The present disclosure makes reference to the use of the disclosed methods and systems for residential real estate renovation work. However, it should be understood that the present disclosure is not limited to residential real estate renovation work. For example, the present disclosure may be applicable to any renovation on any property including, for example, residential properties (e.g., apartments, condominiums, townhouses, detached houses), commercial properties (e.g., office buildings) as well as other types of properties (which may include properties other than buildings).

Although the present disclosure refers to renovations and renovation tasks, it should be understood that these terms are used broadly and may cover related tasks not generally considered renovations. For example, inspections that might lead to renovations, inspection, maintenance and replacement of building systems, appliances, etc, the inspection and replacement of consumables (e.g., batteries, light bulbs, filters) and other such maintenance tasks may also be included. Additionally, renovation process steps such as inspection of the property, quoting and obtaining approval for the work may be considered to be part of the overall renovation task.

### Definitions

The present disclosure makes use of the following terms:

Rental unit: The rental real estate, regardless of configuration (apartment, house, townhouse) will be called the rental unit or, just the unit.

Renovation work: a list of services to be performed and materials to be supplied. Services include (but are not limited to) installation of the supplied materials and removal and disposal of older materials being replaced. Services can include, for example, inspections, testing and maintenance (replacement of consumables, etc). There are various types of renovation work, differentiated primarily by whether the area being renovated is in use or not and what restrictions or limitations exist on the renovation activities. Common examples include, for example: turnover work, service work, and common area work. These differ as follows: In turnover work, the tenant first moves out, and then renovation occurs in an unoccupied unit; In service work, the tenant does not move out, and work occurs in an occupied unit; In common area work, renovation activities are not inside a rental unit, but in common areas (e.g., hallways, stairwells, etc). Renovation in a non-residential setting is similar but may have different restrictions due to applicable laws and client rules.

Scope: a list of renovation items to be installed and activities to be performed. May include implied items (i.e. install new X generally implies remove old X).

Inspection: A visit to the area to be renovated, to determine the condition of all materials, and the size and shape of any components, for the purpose of auditing and/or quoting for current or future replacement.

Superficial Inspection: a non-destructive, non-invasive inspection limited to the visible surfaces and spaces and simple tools and equipment. Such an inspection may not uncover certain issues or defects inside the walls, under the floors, behind access panels or otherwise not readily apparent. For example, a superficial inspection may not detect mould or moisture damage, certain infestation conditions, the condition of plumbing, electrical, heating or other systems, alarm monitoring, non-code-compliant materials or conditions related to the supply of electricity, water, gas, waste removal, communications, data, video or any other services. For example, an electrician with a voltmeter might detect an improper ground condition of the electric supply, but a superficial inspection would not. Depending on the condition, local legal requirements, requirements of the building ownership, etc., this condition may or may not be considered a site condition.

Site condition: a hidden or obscured issue or problem found during renovation, but not detected during superficial inspection. In general, site conditions are revealed by a skilled tradesperson in the course of his/her work. In some cases, detection may require special equipment or instruments. Site conditions, when found, are handled by a set of policies related to the customer and other requirements, including possibly legal requirements.

Invasive inspection: after a site condition is found, an invasive inspection may be required to determine the extent of the problem or condition.

Right of inspection: The landlord (or an agent) has the right of entry to inspect a rental property to determine any wear or damage that may have occurred during the tenancy, and/or any upgrades or changes required by law or management.

Inspection notice: Notwithstanding the above right, in most jurisdictions, the landlord must give, in advance, notice of intent to enter for the purposes of inspection. The laws that pertain to adequate notice vary by jurisdiction.

Termination notice: In many jurisdictions, a tenant is required to give advance written notice to terminate a residential tenancy. This is called the termination notice. The notice period may vary, depending on jurisdiction, lease type and various other factors. For example, the notice period may be 60 days or as little as 30 days.

Move-out date: In the termination notice, a move-out date is given. The move-out date may coincide with the end of the tenancy, or it may be earlier.

Pre-move-out period. The period from when termination notice is given to the move-out date is considered the pre-move-out period.

Pre-move-out inspection. An inspection during the pre-move-out period. Inspection is necessarily limited by, for example, tenant belongings still in the unit, blocking visual access to some parts of the unit.

Vacant: Once the tenant has left the unit, the unit is considered vacant.

Vacancy Inspection: A more complete (but still superficial) inspection after the unit is vacant.

Vacant period: The period after move-out and before the move-in of the next tenant is considered the vacant period.

Vacancy loss: The money not collected during the vacant period is called vacancy loss. It can be a substantial overhead.

Super: We will use the term super for any type of representative authorized to act at the building level for the management of the building. This includes, where applicable, facilities management staff.

Overview of the System and Method

The disclosed systems and methods may be suitable for managing renovation work of various types, as listed in the definitions.

The types of renovation work differ according to access rules, notice pre-conditions, tenant preferences, client requirements and applicable building codes and laws. Under certain conditions, there may be requirements for certain critical services to be restored at a night, weekend or some other boundary. The disclosed method makes the appropriate information available, including the restriction source, when scheduling a renovation component. The method may enforce certain restrictions and/or may allow human override.

A typical renovation may include multiple renovation tasks or activities. One or more activities may have dependencies on one or more other activities (e.g., approval may be required before custom manufacturing baseboards which may not be installed until the floor and walls are done, etc).

These activities, when listed according to their dependencies, form what is known as a PERT chart.

The critical path is that sub-group of activities that are critical in determining the final completion date. A delay in any of them will delay the completion of the overall renovation. Specifically, those core activities establish the renovation timing. By convention, the items on the critical path may be emphasized visually.

A project management technique in common usage to speed up a project may be to move activities, which are not required to be in the critical path, out of it. Another project speedup technique may be to reduce the duration of activities in the critical path by adding more manpower (e.g., hiring more personnel) or calling for overtime after hours or weekend work.

The disclosed system and method for a rental property typically commences with an exchange of information and the assembly of certain resources ahead of time, which allows for the renovation to move more quickly and ensures quick quote approval, problem detection, escalation, response and resolution.

On the technician's side, a pool of skilled technicians for various types of jobs, that are tested and trained to common standards with the ability to add and subtract technicians from the pool, should be assembled. This may require training and testing facilities to ensure a consistent standard.

A communication method to alert the skilled technicians of new work with the ability to update the scheduling function with their renovation progress should also be available. Finally a database to manage and update the information, listing all geographic inputs, training, skills and speed information necessary to schedule the technicians effectively, as well as all contact information, vacation schedules, and similar information would be necessary.

From the client's side, a property list, listing the personnel responsible for each property, the reporting structure and the requisite move-out process are required.

Any agreed upon price list of services, including units of measure, specifications such as paint and fixture type by way of example would also be included. Other mandatory information would also include any policies for the approval process, automatic approval, evidentiary documentation requirements, invoicing requirements, for example.

Other types of information that could be included, but are not mandatory would be any detail on the property including but not limited to, the history of the units and properties, and other property details such as information about the floors, suites and suite types.

All of this information would then be stored, updated and accessed on a database. Conveniently this information may be accessed by client and client policy with the ability to delegate certain of these updates to client personnel and the ability to log and track such client updates so that internal staff are aware of the changes.

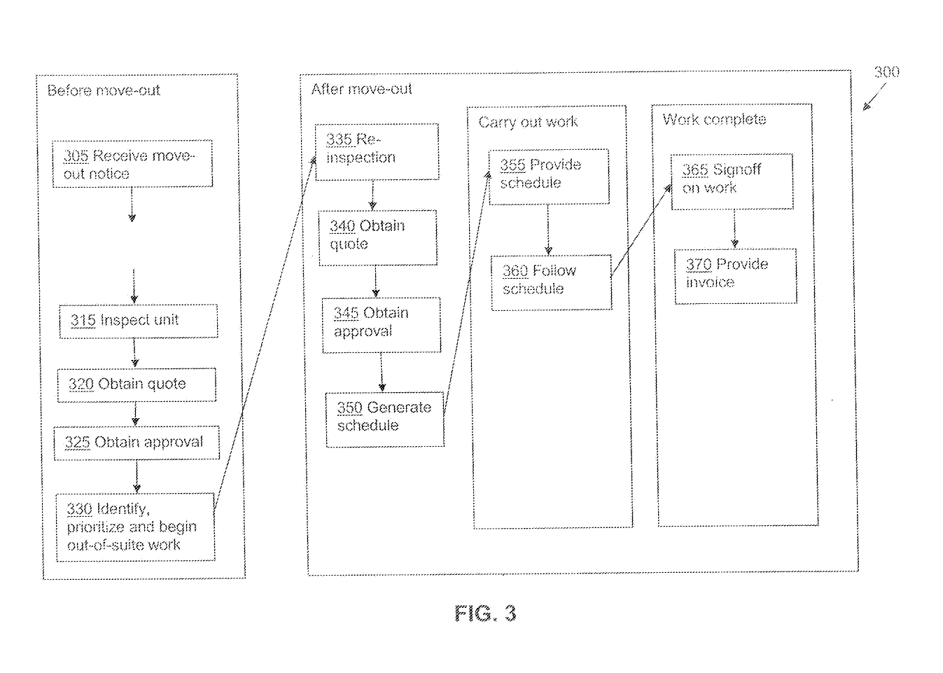

An example of a conventional timeline for turnover work is shown in FIG. 3.

At 305, a termination notice is filed by the tenant. Typically this communication is signaled to either the client management, who then communicates to the system administrator, or else directly to the system administrator who then communicates it to the client.

Based on client policy, an appointment is set up to inspect the premises, with or without building representatives. Client policy determines how the appointment is set up, whom to notify if the appointment is not set up within a certain time, etc.

The next step is the pre-vacancy inspection and quoting process. At 315 a pre-move-out inspection is performed. Typically the inspector is trained to obtain sufficient measurements, information and evidentiary documentation to satisfy all foreseeable requirements stemming from quoting requirements, client policies and downstream requirements of the technicians, and any chargeback requirements. The instant system allows for access to client policies and history to determine if any policies or service issues justify more intense inspection of any particular components. Some landlords exercise their right of inspection during the limited inspection period while others do not.

Steps 320 and 325 outline the quote process. The quote is prepared and sent to head office and is validated where required. It is sent to the appropriate approval authority(ies) based on the requisite client policy. Based on client policy, it may be possible to approve or deny the entire quote and/or do line by line or segment by segment approvals.

If line-by-line approval is allowed, the logic may disallow certain scope changes that make no sense from a renovation perspective (for example, cannot remove requirements placed in the file by building code requirements without also removing the causative item). Approval also has escalation policies and sequences associated with the client. The logic may access previous renovation history. For example, when reglazing tubs, if the tub has been previously reglazed, it must be stripped before reglazing. Attempts to remove the strip operation would be disallowed.

Upon approval, those custom items which can be manufactured out-of-suite are initiated, step 330. Any inventory pulls are scheduled and encumbered for the period after projected vacancy. Inventory can be encumbered against (and later pulled from) separate warehouses, including on-site or off-site client warehouses. Any restocking activities as a result of the above can be initiated.

At this point, the process then determines if the property has been vacated. If the property has not been vacated, and depending on the circumstances, appropriate client policies, including emails and email escalations, can be brought to bear at this point.

After move-out, step 335, vacancy inspection and quote modification may occur. If specified by client policy, a unit may be re-inspected at vacancy. Such a re-inspection can catch items missed because they were not visible at pre-inspect, changes to the unit since pre-inspect, or vandalism, by way of example only. If vacancy inspection creates any differences in scope, any changes may be automatically authorized or quoted in a change order for client approval, depending on client policy (steps 340 and 345 respectively).

If the changes require approval, there is more urgency to getting this change order approved. Client policy for escalations is likely more stringent. Once the entire scope is established, scheduling of technicians can occur (350). According to client policy, the renovation schedule, once established, may be sent to one or more client representatives.

At step 355, renovation can commence and depending on the client, the site and the scope, there may be start-up activities such as renovation signage, key and/or access requirements, parking provision for technicians, or demolition by way of example.

Typically a “renovation clock” is started which is similar to chess clocks.

Specifically, a first clock ticks during any renovating, but is then stopped when waiting for a response from the client. A second clock ticks, namely the client's clock when the renovation is on hold. At the end of the renovation, it is then possible to account for all the time spent, which is split into time spent renovating and time spent waiting for a response from the client.

During the actual renovation work, step 360, technicians and materials are dispatched to the job site(s) on a regular basis, according to the schedule. Also on a regular basis, according to the schedule and policies in the database relating to the specific type of renovation work being done or recently completed, project management is dispatched to the job site to inspect the work done or in progress.

During renovation, a technician can detect a site condition. In this case, a policy or set of policies which apply to that site condition are acted upon. The range of actions can include repair, remediation, or stopped for client approval to proceed, amongst others. Site conditions that stop renovation for client approval may put the renovation on hold. Such a site condition will likely effect the rest of the schedule. The schedule is redone as soon as a likely restart time is established. Because of the common training of technicians, work originally scheduled for one technician may, in the reschedule, be assigned to another.

Once the renovation is complete, client specific policies surrounding signoff documentation and process are followed, steps 365 and 370. After signoff, an invoice is issued to the client. The invoice may contain any client-specific marking or coding, according to client policy. For example, installation of water or energy saving devices may be coded to go into a specific General Ledger account, so as to accumulate and qualify the client for rebates. The invoice may be created in physical paper or in any of a number of electronic forms. The invoice may be delivered immediately (for example, by email) or may be batched and delivered on a schedule (nightly email, weekly courier, etc). According to client policy, the invoice may contain, as appendices, backup documentation such as before and/or after photographs, other appropriate evidentiary documentation, any certificates or permits obtained, proofs of attendance, etc. The unit is now in a condition to re-rent and can be flagged as rent-ready.

Any of the activities listed above may be logged in a time stamped log for audit purposes. The log may contain every action, who took the action, and the effect on the renovation cycle. Many log entries contain a comment or note field as well. The log is viewable by client representatives (subject to client policy) and staff.

The disclosed system and method for a non-rental property typically commences in a similar fashion to that described for a rental property where a client (or client policy) signals a renovation requirement. The process follows a similar path to that outlined for a rental property, namely inspection, quoting, quote approval, renovation commencement, work and completion. Typically checking for vacancy, vacancy inspection and quote modification are not required for a non-rental property.

The disclosed methods and systems may allow for managing renovations in that they may: i) provide the history of work in a unit, a building or a portfolio, ii) utilize that information to decide specifics in a unit and/or iii) identify the competitive pressures on the building, brought down to the individual unit level for action. Such information may be provided outside the vacancy loss period, where there may be more time to consult and make the best decision.

Furthermore the disclosed methods and systems may help to manage renovations by providing appropriate coordination of information. For example, if management has decided that 15% of all kitchen cabinetry in a building needs to be upgraded to move the building up-market, and if that quota has not been met, and if that unit is to be renovated with new cabinets anyway, then the disclosed systems may provide information to suggest that the new cabinets should be upgraded to the higher quality ones. Conversely, the disclosed system may determine that the budget is already overspent for this year, and the upgrade should not be carried out, or further funds should be borrowed from next years budget, for example. This may be also applicable to, management of utility costs at a per-unit level. For example, if it is considered desirable to replace all older refrigerators with energy star ones, the disclosed system may identify the age of the existing unit whether it is energy star rated or not and help to make a decision whether the replacement should be done. The disclosed system may help with similar decisions for introducing low flush toilets, and taking advantage of government or other rebate programs for various upgrades (e.g., energy, efficiency, insulation).

The disclosed method may provide, via sufficient prior renovation history in the unit or else via a general building audit, the ability to “autoscope” a unit. This would allow a comparison of the last replacement time and the anticipated life of the various components so as to produce a checklist to guide the inspection and ensure items nearing their expected lifetime are checked more carefully. As a result significant time will not be spent on new items not expected to be problematic.

Example of the Disclosed Methods and System

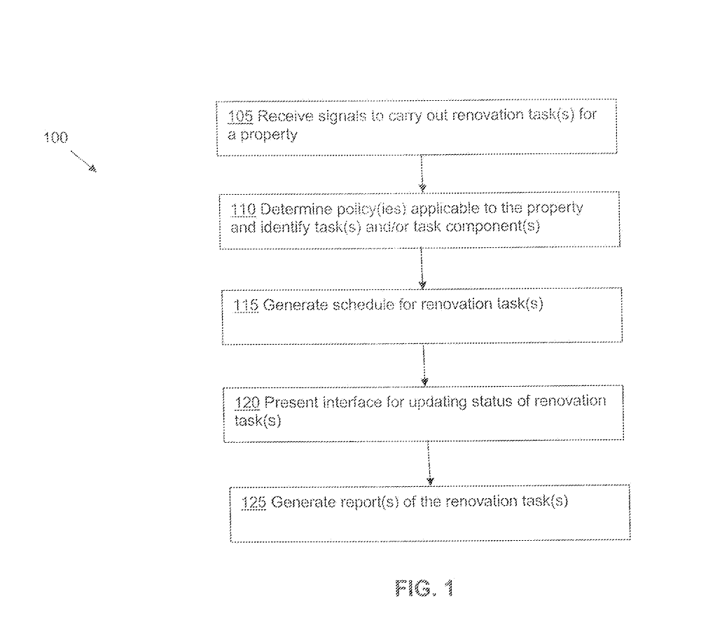

An example of the disclosed system is now described with reference to FIG. 1

The example method 100 may be suitable for managing renovation of any suitable property including, for example residential properties (e.g., apartments, condominiums, townhouses and detached houses, among others), commercial properties (e.g., office buildings) and any other suitable properties. The method 100 may be used for turnover work, service work and/or common area work. The method 100 may be carried out by one or more processors, or any other suitable system as will be described further below. In the method 100, there may be one or more users involved. For example, the user(s) may be any personnel involved in the property and/or the renovation including, for example, a building super, a building higher authority, a contractor, a third-party inspector or any other such personnel.

At 105, signals are received representing instructions to carry out one or more renovation tasks for the property. The signals may be, for example, input by a user (e.g., a super of the property, via an interface) or generated internally by the system (e.g., an internal trigger). Where the signals are internal to the system, the signals may be triggered by satisfaction of one or more predefined conditions, such as a predefined time (e.g., beginning of summer allows for outdoor renovations), a predefined schedule (e.g., a pre-scheduled renovation), an availability of personnel (e.g., a contractor has finished another job and is now available for new work), an availability of funds (e.g., entering a new budget year opens up new funds), pre-defined duration (elapsed time since last filter or battery change) or any other appropriate conditions.

The instructions may provide additional information including, for example, identification of the property to be renovated, start date of the vacancy period and/or identification of one or more desired renovation tasks. In some examples, the instructions may not specify any renovation tasks.

At 110, a database may be queried to determine at least one policy applicable to the property. The database queried may be a policy database. The policy database may contain various policies relating to renovation tasks. A policy may be any guideline, rule or relationship that may be used to make renovation decisions. Examples of policies may include: budget guidelines, types of renovation for specific properties, rules to avoid certain renovations for specific properties, predefined timelines for certain renovations, preferred list of contractors, and any other suitable policy that may assist in making renovation decisions.

Determination of the at least one policy may be based on information provided by the instructions to carry out the renovation task(s). For example, the instructions may specify particular renovation task(s), in which case only policy(ies) pertaining to the specified task(s) may be determined to be applicable.

Determination of the policy(ies) may also be based on the results of a query to a property database. The property database may contain information about all properties in general, certain types of properties and/or specific properties. For example, the property database may contain information that all properties have battery-powered smoke detectors, in which case any policies pertaining to battery-powered smoke detectors (e.g., rules for the frequency of replacing batteries on a smoke detector) may be determined to be applicable. The property database may contain information about types of properties. For example, the property database may indicate that all single bedroom units are carpeted, which may be used to determine if the property to be renovated is carpeted and if so, any policies pertaining to carpets (e.g., rules for cleaning the carpet before the next tenant arrives). The property database may also contain information about specific properties. For example, the property database may indicate that the property to be renovated has iron pipes or aluminum wiring, building materials which are now deprecated and should be removed and replaced as part of a managed, preventative maintenance policy.

Where the instructions specified renovation task(s) to be performed, policy(ies) may be determined that are applicable to the renovation task(s). For example, where painting is specified as a renovation task, a painting policy may be applicable (e.g., types and colours of paint, a list of preferred painters).

The policy(ies) may also be used identify additional renovation task(s) that should be done, even if the instructions already specify some renovation task(s). For example, where the instructions come from input by a building super that a unit will be vacated and painting is needed, the super may not be aware that the unit has had a water leakage problem, or that the unit has not replaced aluminum wiring or steel pipe. In the example method 100, the history of the unit may be recorded in the property database and this history may be used to identify a policy that specifies that any unit with specified reported problems require specific inspection and renovation. In this way, even though the super lacks knowledge about the history of the property, the appropriate renovation task(s) may be identified.

Additionally, the specified and/or identified renovation task(s) may cause the inclusion of additional applicable policies. For example, if it has been determined that removal of steel pipe is required, the identification of this renovation task may lead to a determination of a further policy that says the building has a history of defective shutoff valves, and provision should be made for a building water shutdown. Building water shutdowns require (in many jurisdictions) 24 hour notice to all affected tenants. There may be additional lead time requirements, having to do with material availability or additional landlord policies.

At 115, after all the appropriate task(s) for the property have been identified, a schedule is generated for the renovation task(s). The schedule may be generated by identifying at least one preferred time period for carrying out at least a portion of the renovation task(s), and prioritizing performance of at least that portion of the renovation task(s) during the preferred time period. The preferred time period may be determined based on the applicable policy(ies) determined above. The preferred time period may be, for example, an economically preferable time period (e.g., cheaper to renovate during the less busy winter season), a more convenient time period (e.g., during the night when less tenants will be inconvenienced), a period of higher personnel availability (e.g., in the winter when contractors are less busy), or any other suitable definition of a preferred time period.

The portion of the task that should be prioritized may also be identified by the policy(ies). A renovation task may include one or more components that may be identified by the policy(ies) as being suitable to be carried out in the preferred time period. For example, a typical renovation task may include, as components, inspection of the property, obtaining a quote for the work and obtaining approval of the work. These components may be carried out during the pre-moveout period when there is not yet vacancy loss. In this case, the pre-moveout period may be identified as the preferred time period and the components of inspection, obtaining a quote and obtaining approval may be prioritized to be carried out during the pre-moveout period.

Where there is a plurality of renovation tasks being carried out (whether staggered in time or starting at the same time), the schedule may also be generated to coordinate interaction among these tasks. For example, where two renovation tasks have components that share one or more resources (e.g., both installation of cabinets and installation of doors use the same contractor) the schedule may be generated to overlap or bring together those components, in order to optimize the use of those resource(s) (e.g., installation of cabinets may be scheduled concurrently or immediately after installation of doors in order to efficiently use the contractor's time).

The generated schedule may be provided to a user (e.g., printed out on paper for a super, displayed on an interface, transmitted to appropriate personnel and/or communicated in any other suitable manner).

At 120, an interface is presented for updating status of completion of the renovation task(s). In some examples, the interface may be presented as a graphical user interface displayed on a screen of a computing device (e.g., a desktop computer, a handheld device, a tablet device or any other suitable device). The interface may receive status updates as input (e.g., a contractor or other user may enter the date of completion of certain task components) or any other information (e.g., the interface may receive information updates such as the amount quoted). The interface may be presented to multiple users on multiple devices (e.g., the super and the contractor).

In some examples, the user may be required to log in (e.g., through the use of a unique PIN, passcard or password) or otherwise gain authorized access to the interface. Such log in may be used to verify the identity of the user, for example to ensure that the user has the appropriate authority level for certain interface options. In some examples, based on the user information provided at log in, different interfaces may be presented (e.g., the super may be provided with a more detailed global interface and the contractor may be provided with an interface related only to one specific renovation task). The interface may also provide different users with different options, based on the user information provided at log in. For example, a user with higher authority may be provided with more options (e.g., a building authority may be provided with an option to approve a quote) than a user with less authority (e.g., a contractor may only be able to view whether a quote has been approved).

The interface may also include communications to the user(s) (e.g., emails, SMS, text message, automated voice messages) providing information. For example, the interface may send an email to a contractor at preset time periods asking for a status update. Such communications may also provide the user with information and/or the means to input a status update (e.g., a text message may include a URL link to a webpage for entering a status update, or a voice message may include a telephone number to call to record a status update). The interface may also provide specific information and/or mechanisms only to specific user(s) (e.g., invoices for work may be inputted by the contractor and may be provided only to the building authority).

For example, where a task component is approval of a quote, the interface may require input from the approval authority to verify that the scope and need for the quoted work has been checked. This may be recorded (e.g., for traceability purposes) and stored in an appropriate database. The approved quote may be further verified (e.g., against one or more applicable policies) to ensure that the quote meets reasonableness criteria. For example, where the method 100 has identified a policy that sets a quote cap as being applicable, this quote cap may be automatically compared to the approved quote to ensure that the quote complies with the policy. If the quote does not comply, this deviation may be notified to the approval authority, a higher authority and/or recorded and stored for further investigation. The interface may also communicate notifications (e.g., by email or automated voice message) to the approval authority that a quote is available for approval. The interface may also communicate reminders, alerts or warnings (e.g., to the approval authority and/or to a higher authority) where response to a quote is not received from the approval authority within a preset time period (e.g., as determined in the generated schedule and/or according to a policy specifying quote approval timing).

The approval authority may be provided with options on the interface to approve or deny the quote (e.g., either on a line-by-line basis or in total) or even upgrade the quote. The interface may require input from the approval authority to verify that the approval authority has the proper level of authority to approve a quote. For example, the identity of the approval authority may be verified by input of a PIN, a handwritten signature (which may be recognized by suitable pattern- or handwriting-recognition algorithms), a pass code or a pass card, password and biometrics for example.

The interface may present user(s) with data (e.g., reports), whether stored or newly generated, in raw or aggregated forms. Such data may be restricted to certain authorized personnel, where appropriate.

The interface may also guide and/or facilitate input of information by providing templates for entering input and/or pre-filling input information. Such templating and/or pre-filling may be based on data in the property database and/or personnel database, for example, and/or may be based on one or more policies.

Any input (e.g., status update information) received via the interface may be logged (e.g., time, date, type of transaction and identity of user) and stored for future reference.

The interface may be accessible locally (e.g., at the site of the renovation) as well as remotely (e.g., at a client office, the office(s) of any effected contractors, the general contractor, and in any kind of mobile facility like a construction trailer or in a vehicle associated with the general contractor, a sub-contractor or a client).

The interface may be accessed by multiple users simultaneously. However multiple users may be prevented from working on the same renovation unit at the same time and/or may be warned that others are updating/viewing/modifying the same unit at the same time and/or may receive no such warning, depending on policies.

The interface may provide communications (e.g., notices or alerts) to the appropriate personnel if particular input is required. The interface may also provide communications (e.g., notices or alerts) if expected input is not received (e.g., completion status is not entered for a given component by the scheduled completion date). Such communications may be sent to the personnel at fault (e.g., the contractor assigned to that component) and/or may be escalated to a higher authority (e.g., a super).

The user(s) may interact with the interface via various input and output systems that may support, for example, color, 3D, motion, holography, sound and/or tactile information.

In some examples, a status update may indicate a deviation from the generated schedule. For example, a component of a task may be behind schedule (e.g., approval of a quote took longer than scheduled), a new task may be required (e.g., work on the sink may reveal that plumbing work is also needed), a task may be found to violate a policy (e.g., all quote for the work may exceed the maximum budget), among other possible deviations. In such situations, the method may return to step 115 to re-generate or adjust the schedule to accommodate the deviation (e.g., by shifting back the timeline, by incorporating a new task or by re-scheduling a component of or all of a task).

Any deviations may be tracked and/or logged (e.g., in a deviation database) and such information may be used for self-learning of the method 100, as will be described further below.

Any deviations may be brought to the attention of one or more users via the interface. For example, a super may be alerted to a deviation by a communication from the interface (e.g., an email alert). Any adjustments to the schedule may also be communicated by the interface to the user(s) involved.

At 125, a report is generated for the renovation task(s). The report may be a completion report (e.g., reporting on final costs and work done), a status report (e.g., reporting on the completion status of the task(s)), a milestone report (e.g., reporting on the completion of a component of the task(s) or reporting on the status upon reaching a milestone such as the end of the preferred time period) or any other suitable report. The report may be generated to be displayed on the interface (e.g., on the screen of a computer monitor) or as a physical document (e.g., a printed report), for example.

The report may be stored in a report database for future reference (e.g., for liability purposes), may be duplicated and propagated as appropriate, may be accessible only by authorized personnel (e.g., only the super and higher authority may view the report via a secure login) and/or may be transmitted physically and/or electronically (e.g., as an email communication).

Although the method 100 is described as beginning with instructions to carry out the renovation task(s), it should be understood that there may already be one or more other ongoing or future scheduled renovation tasks.

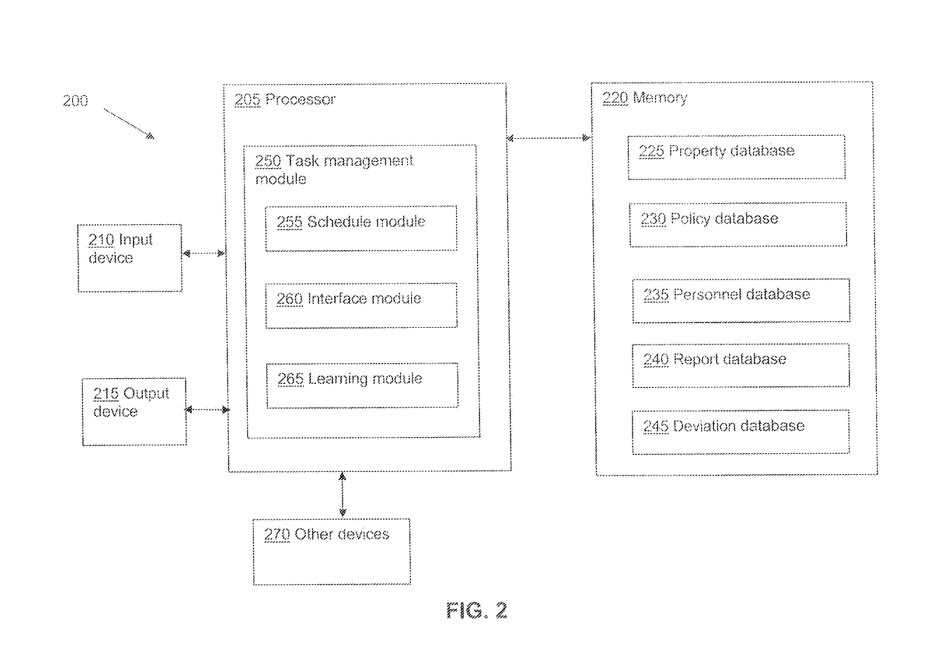

Reference is now made to FIG. 2 illustrating an example of the disclosed systems for managing renovation of a property. The system 200 may be used to implement any of the disclosed methods, including the method 100 described above.

The system 200 may include one or more processors 205 configured to carry out the disclosed methods. Although one processor 205 is shown, it should be understood that the functions described for the processor 205 may be carried out by more than one processor 205. For example, there may be a plurality of processors 205 that communicate with each other (e.g., via direct connection, wireless connection, an intranet or the Internet). The processor(s) 205 may include any suitable computing device including, for example, a desktop device, a handheld device, a tablet device or a server.

The processor(s) 205 may receive input from user(s) via one or more input devices 210 (e.g., a keyboard, a mouse, a touch-sensitive screen, a scroll button, a microphone or any other suitable input device). The processor(s) 205 may provide output to user(s) via one or more output devices 215 (e.g., a display screen, a speaker, a vibrator or any other suitable output device). The input device(s) 210 and/or the output device(s) 215 may be integral to the processor(s) 205 (e.g., a handheld or tablet device may have integrated input and output devices), may be directly connected to the processor(s) 205 (e.g., a desktop device may have cables to connect to input and output devices), or may be wirelessly connected to the processor(s) 205 (e.g., via a Bluetooth connection or via the Internet), for example.

The processor(s) 205 may have access to one or more memories 220. This access may be internal or external to the processor(s) 205, and may be direct or indirect (e.g., wirelessly and/or via one or more other servers or processors). The memory(ies) 220 may be internal and/or external to the processor(s) 205 including, for example, RAM, ROM, flash memory, external storage media or any other suitable memories. Although one memory 220 is shown, it should be understood that the information stored may be stored by a plurality of memories 220. Where there is a plurality of memories 220, each memory 220 may be accessible to each other or may not be accessible to each other.

In the system 200, the memory(ies) 220 may store information in one or more property databases 225, one or more policy databases 230, one or more personnel databases 235, one or more report databases 240 and one or more deviation databases 245. These may be separate databases or may be combined databases. Different databases may be stored in different memories 220. Different memories 220 may also store duplicates of the same database or may store portions of the same database. The databases may be accessible by the processor(s) 205.

The property database(s) 225 may store information pertaining to one or more properties (e.g., address, current tenant, size, age, type and history of a property). The property database may also store the jurisdictional location of the building, for the purpose of determining what building, electrical and plumbing codes apply to the site, and what landlord/tenant rules apply. The policy database(s) 230 may store one or more policies (e.g., the policies described in the method 100). The personnel database(s) 235 may store information pertaining to one or more personnel (e.g., contractor name, contact information, abilities, certifications, expiration date of any certifications, responsibilities, access level, authorization level, availability and level of preference). Personnel may be a property owner, a super, a building authority, a contractor, rental agent or any other suitable personnel. The report database(s) 240 may store one or more generated reports (e.g., any reports generated in the method 100). The deviation database(s) 245 may store information pertaining to one or more deviations (e.g., any deviations detected in the method 100). Although the above information has been described as being stored in certain separate databases, it should be understood that in some examples this information may be stored in a combined database or in different databases.

The databases 225, 230, 235, 240, 245 may together store some, most or all information required for a renovation task, and the information stored therein may be updated via the interface.

Information stored in the property database 225 may include a list of all properties and their attributes, including, for example identification (e.g., address and suite number) unit type (e.g., house, apartment or townhouse), configuration (e.g., single bedroom or double bedroom) and/or any specifications (e.g., preferred paint or fixtures). Some of this information may be collected and/or updated during the renovation process and may be subsequently stored to avoid having to collect such information at the next renovation.

The property database 225 may be linked and/or cross-referenced to the personnel database 235, to identify which owner owns which property, for example. This may help to determine which policy(ies) are applicable to which property. For example, certain owners may have particular policies not shared by other owners, in which case those particular policies may be applicable only to the properties owned by those certain owners and not to properties owned by other owners, even if the properties are all within the same building.

Information stored in the personnel database 235 may also include a list of personnel responsible for each property, and any reporting/authorization hierarchy for each personnel, where appropriate.

The policy database 230 may also store policies that outline a list of standard communications that can arise, and any pre-arranged decisions and/or protocols for how communications should be handled. For example, policies may outline how move-out notice should be communicated and to whom, as well as how inspection dates and completion dates should be communication and to whom.

Other examples of policies that may be stored in the policy database 230 include policies that are specific to particular personnel. For example, certain owners may be provided with certain exclusive services (e.g., where a building owner has paid for a more advanced version of the disclosed methods and systems).

The policies may be linked and/or cross-referenced to particular personnel (e.g., building owner). For example, a building owner who is a client of the disclosed methods and systems may have preferred policies for renovation work that may be unique to that client. Such policies may include lists of trusted contractors, communication protocols, pricing and budget guidelines, material preferences, timing preferences, or any other suitable policies, for example. Since the property database may be linked and/or cross-referenced to the personnel database, the policy(ies) specific to a particular client may be thus identified as being applicable to the property(ies) related to that client.

In some examples, the policies may also include one or more policies guiding the services the disclosed methods and systems will provide to particular clients. For example, some clients may pay for more services while others may not, or other clients may have negotiated particular sets of services. Such services may include types of renovation work that the client may manage using the disclosed methods and systems.

For example, for each renovation service, a policy may outline a cost basis for the work (e.g., per unit, per room, per linear measure, per square measure or per piece), price for the service, wording for the quote (e.g., including details of the customer spec, for verification), invoice wording (if different from the quote wording) and/or GL code where required by a client.

For each customer service or group of services, policies may include customer criteria, if specific criteria exist, for service selection. For each customer service or group of services, policies may include a list of evidentiary data required to substantiate the need for this customer service. The policies might also indicate a customer-specific preference for method or order of renovation, where such options exist.

The policy for each renovation service or task may also include a list of component parts of that task and the time sequence of each component (e.g., purchasing, manufacturing, removal, disposal, installation and finishing).

The processor(s) 205 may be configured to implement one or more modules, for example the processor(s) 205 may implement a task management module 250 to carry out the method 100. Although the task management module 250 is shown as being internal to the processor(s) 205, it should be understood that the task management module 250 may be external to the processor(s) 205. In some examples, the functions of the task management module 250 may be carried out by one or more other modules.

In this example, the task management module 250 may include a schedule module 255, an interface module 260 and a learning module 265. The schedule module 255 may be implemented by the processor(s) 205 in order to generate a schedule for one or more renovation task(s), for example as described in the method 100. The interface module 260 may be implemented by the processor(s) 205 in order to provide one or more user interfaces, for example as described in the method 100. The interface may be implemented using any suitable means including, off-the-shelf products such as Microsoft SharePoint. The learning module 265 may be implemented by the processor(s) 205 in order to perform self-learning, as will be described further below.

In the system 200, the processor(s) 205 may communicate with one or more other devices 270 directly (e.g., via a cable connection) or indirectly (e.g., via a network connection or via the Internet). This may allow the processor(s) 205 to provide an interface to and communication with user(s) on the user(s)'s own device(s) 270. In some examples, the other device(s) 270 may serve as the input device(s) 210 and/or the output device(s) 215. Other device(s) 270 may include, for example, handheld devices, desktop devices, tablet devices, telephone devices, vehicle-based devices or any other consumer devices.

In some examples, one or more of the databases 225, 230, 235, 240, 245 may be SQL-based hierarchical database, or any other suitable database structure.

In some examples, the disclosed methods and systems may exhibit a self-learning ability (e.g., machine learning or neural network). For example, the disclosed methods and systems may have a pattern-recognition ability allowing for creation and/or application of policy(ies) either automatically and/or by a user.

For example, if over a number of renovations the task of replacing a hardwood floor was regularly behind schedule because the component of waiting for the varnish to dry took too long, this regular delay may be identified by the disclosed methods and systems and flagged to the user. This may bring an otherwise overlooked problem to the user's attention. The user may then create a new policy that replacement hardwood floors should use pre-varnished material. In another example, if over a number of renovations quotes from a certain contractor are always rejected, the disclosed methods and systems may automatically modify the policy listing preferred contractors to exclude that certain contractor.

In another example, if over a number of renovations it is found that quotes below a certain threshold are always approved, the disclosed methods and systems may automatically generate approval of such quotes without input of an approval from the user(s).

In another example, if the usage of certain materials has a history of causing unscheduled warrantee issues across a statistically significant set, the system could signal the need for both preventative and maintenance activities, that is, suggest the procurement of different materials on a go-forward basis, and highlight where the material was previously used, in order to suggest either substitution or a more aggressive inspection cycle in those locations, in the suites where they have been deployed, so as to turn unscheduled failures into preventative maintenance.

Any changes arising as a result of such self-learning (e.g., removal of a contractor from the personnel database or automation of approval) may be flagged to the user(s) (e.g., communicated to the super via an email) and may require approval from the user(s) before proceeding.

In some examples, some or all this self-learning ability may be activated or deactivated by the user client policy, contractor policy and/or user preference. For example, a building super may be initially unsure about the self-learning ability and may deactivate it. As the super becomes comfortable with the system, the super may activate the self-learning ability for added efficiency and convenience.

The disclosed methods and systems may be implemented as a centralized system (e.g., the processor(s) 205 may be one or more servers) that may be accessed by individual client devices subscribing to the system. In such an example, one or more of the databases 225, 230, 235, 240, 245 may be shared among clients (e.g., where clients share the same contractors) or may be unique and private to certain client(s) or group(s) of clients. Unique log in information, including verification information (e.g., PIN or password) where appropriate, may be used to identify the client accessing the system, in order to identify the appropriate database(s) 225, 230, 235, 240, 245 to use, for example.

The disclosed methods and systems may provide various advantages.

For renovations taking place because of a moveout, the disclosed methods and systems may allow for any time-consuming compound task to be decomposed into separate components, and the components scheduled to minimize the number of components taking place during the vacancy loss period and/or to minimize the number of components in the critical path. For example, conventional processes may link inspection, obtaining quote and obtaining approval in the critical path, whereas using the disclosed methods and systems, these components may be separated from each other and one or more moved out of the critical path.

Where components differ significantly in time from conventional processes, retraining and/or reassigning of personnel may be necessary. For example, rather than having each technician come in and measure his own material requirements, a new personnel position, a trained estimator, may be created to collect all required information in a single visit.

Where a task has been decomposed into components, the components may be further decomposed into smaller components, as appropriate. Even where decomposition was not suitable, efficiencies may be found by identifying opportunities for parallelism. For example, in larger units, two or three person paint teams may take a day to finish a paint job that would take a single painter two or three days. In such situations, the disclosed methods and systems may include policies that recognize this advantage, including policies detailing which contractors have the ability to hire more assistants and any warning or lead time they might require to pick up assistants. Similar opportunities may exist for tile setters, drywallers and various other skilled laborers.

There may be policies that specify, ahead of time, what information is needed to decide and approve spending, and such policies may provide information for the schedule and/or the interface to guide inspection and data collection.

The disclosed methods and systems may provide a notification system to user(s) involved in the renovation, and may provide additional feedback for non-response. Reminders may be generated (e.g., via the interface) and, when that is insufficient (e.g., when personnel is away due to vacation or illness) escalated notifications (e.g., to a higher authority) may be generated by the interface.

The disclosed methods and systems may provide a root cause analysis of where time is lost during renovation, and may provide practical strategies for prevention, time and cost risk reduction, identification of the failing process and/or personnel (which may trigger retraining if necessary) and/or removal of the failing process and/or personnel.

The disclosed methods and system may also provide interface(s) that facilitate and/or guide one or more of: measuring for material requirements and quoting purposes (e.g., an interface may be provided to the user(s) to enter measurements of the property, and the property database may provide information to simplify, supplement and/or omit manual measurements); collecting any additional documentation required to support the quote (e.g., pictures or signatures) (e.g., an interface may be provided to the appropriate user(s) to guide in collection of the necessary information); quoting of the work (e.g., an interface may be provided to a contractor with the measurements and other information for preparing a quote and may also allow the contractor to enter a quote); sending the quote for approval (e.g., an interface may communicate the inputted quote(s) to the appropriate authority for approval); and escalating quote approval in the case of non-response (e.g., an interface may send reminders to the authority if approval of a quote is not received in a preset time period); among others.

The disclosed methods and systems may also allow for coordination of one or more of: any custom manufacturing activities; any special order inventory items; any resupply orders for stock inventory; and scheduling and manpower management; among others.

The disclosed methods and systems may allow for identification of any custom manufacturing components recently approved (e.g., by receiving a status update via the interface that a quote has been approved) and communicate notification to the manufacturer to proceed with timely manufacture of the components (e.g., according to the generated schedule).

The disclosed methods and systems may allow for identification of any inventory replenishment requirements (e.g., by region or warehouse, as appropriate), by considering lead time and delivery schedules and scheduling replenishment appropriately for cash flow purposes. This may be guided by appropriate policies (e.g., policies may provide information on the expected lead time and delivery times of certain inventory, and this may be accounted for in the generated schedule).

The disclosed methods and systems may allow for checking, before the end of the preferred time period (e.g., shortly before an anticipated move-out), that all prioritized tasks and/or task components have been completed (e.g., this may be verified by checking the completion status received for all such tasks and/or task components), identify any that have not been completed and generate appropriate reminders or notifications to expedite such activities.

The disclosed methods and systems may allow for verification that move-out has occurred (e.g., by verifying that input has been received indicating that move-out has occurred).

The disclosed methods and systems may allow for identification of any additional renovation tasks that were not identified before (e.g., such identification may be made after a move-out date, after the tenant has vacated the property). Such additional renovation tasks may not have been identifiable during the preferred time period, for example because of lack of access to the property. Such additional tasks may include, for example, damage to walls previously hidden by furniture or damage to floors previously hidden by carpet. Such additional tasks may be incorporated into the renovation schedule, including scheduling for a quote revision and expedited quote approval.

The disclosed methods and systems may provide communications to the appropriate personnel when various states of the renovation work takes place (e.g., in-suite work). Such communications may be provided to different personnel at different times (e.g., different technicians may be notified to begin their respective work at different times, according to the schedule, to ensure that the work is done in an efficient sequence). Such communications may include information including, for example, instructions for the work, the address for the work, information about the appropriate materials to use and any other suitable instructions. Such communications may be provided at appropriate intervals, for example daily before the workday begins.

The disclosed methods and systems may help to ensure that the appropriate personnel has quick and easy access to the property under renovation (e.g., by providing the appropriate information), and may also be used to maintaining records (e.g., for auditing purposes) of entry and exit times for the renovation work.

The disclosed methods and systems may help personnel (e.g., contractors and technicians) to quickly and accurately report progress and/or status of tasks or task components.

The disclosed methods and systems may help to track materials and inventory for a renovation, including tracking any excess materials, and verifying that the excess is appropriately returned.

The disclosed methods and systems may allow for objective and/or traceable verification of job completeness and/or quality.

The disclosed methods and systems may allow for personnel to identify, record and/or raise notification of any deviations (e.g., an unexpected site condition). The disclosed methods and systems may facilitate a response to such deviations including, for example, facilitating change orders for renovation work on the site and expedited approval process for any additional work required. On a per client policy basis, such deviations may call for the production of evidence such as photographs, return of defective materials, etc.

Example of Move-Out Renovation

The disclosed methods and systems will now be described in operation with respect to an example moveout renovation (i.e., turnover work). This example method 300 is illustrated in FIG. 3. The method 300 may be based on the method 100, with appropriate variations and/or details pertaining to an example moveout renovation.

At 305, the method 300 may begin with receipt of a moveout notice (e.g., inputted via the interface) for a particular unit. This information may be sufficient to identify and schedule renovation tasks, to generate a renovation schedule, as described above (e.g., where there are certain renovations that are always conducted for moveouts).

At 310, a joint pre-move-out inspection date may be scheduled, for example according to the methods and systems described above.

At 315, the example method and system may provide an interface to guide inspection of the unit shortly after move-out notice has been given, to determine the majority of work required. Policies of the example method and system may guide selection of the person performing the inspection, to ensure that person has appropriate training to capture appropriate inspection data. The interface (e.g., provided to the inspector on a handheld or tablet device) may be used to guide inspection in real-time and/or to flag for special treatment all those items deemed to have unreasonable wear and tear, damage or other lease violations (e.g., unacceptable paint or wallpaper). In some cases, flagged damage may be charged back to the tenant. The interface may also guide and/or facilitate collection of evidentiary data (e.g., photographs). The method may collect information and track attendance of the super at these inspections. The information collected during the inspection may be fed back to the example methods and systems to identify and schedule any additional renovation tasks. Approximately 90% of the renovation work required may be identified at this point.

At 320 and 325, the example method and system may facilitate relatively quick obtaining of quotes and approvals for renovation tasks. Appropriate information and/or guidance for making relevant decisions may be provided to the appropriate user (e.g., personnel having authority to approve a quote) by the interface of the example system.

At 330, the example method and system may generate a renovation schedule that prioritizes tasks and task components that may be done in the pre-move-out period. For example, any out-of-unit work (e.g., custom manufacturing, material and labor provisioning or scheduling) may be identified and schedule to be carried out in the pre-move-out period.

At 335, a re-inspection may be scheduled by the example method and system after move-out to gather information for identifying any additional renovation work not identified at the early inspection.

If additional work is identified, then at 340, 345 and 350 the renovation schedule may be adjusted accordingly, to reduce or minimize any delay. Quoting and approval of this additional work may be expedited.

At 355, generated schedules, including any schedule adjustments, may be communicated to the appropriate personnel (e.g., technicians, site personnel, system administrator, sales staff or the super). The schedule may include a predicted completion date so that the property may be re-listed for rent by the predicted date.

At 340, renovation work is carried out by the appropriate personnel according to the generated schedule. The interface may be used throughout the renovation work to update the completion status of tasks or task components. The interface may also be used to communicate notices, alerts or reminders, for example, to maintain the scheduled timeline.

At 345, once the renovation work has been finished, the appropriate personnel (e.g., building authority) may signoff on the work. The signoff may be facilitated by information provided by the interface.

At 350, invoicing for the work may be facilitated by the interface, as described above.

The example method and system may allow for monitoring schedule compliance and may assist in bringing work back into schedule compliance when slippage occurs. In some situations, a user may indicate via the interface that work on a property is to be put on hold, and may indicate a reason. At this point, the renovation schedule may be frozen. When the property is removed from hold, the renovation schedule may be reactivated and updated if necessary to account for the hold. Work orders may also be changed and/or cancelled via the interface and the renovation schedule may be adjusted accordingly.

The interface may be used by a user (e.g., a super or higher authority) to signoff on completed work. The interface may also generate and/or communication invoices to the appropriate user(s). For example, invoices may be automatically generated when a contractor inputs completion of a task or task component. Invoices may be GL coded for better integration into an accounting system or accommodating special capital improvement initiatives, for example.

The example method and system may log and record all inputs, outputs and transactions, allowing reports (e.g., event logs) to show what happened in a particular property, in time-sequence order, for example.

The interface may serve as access control and/or a web-based portal to view the state of work in one or more properties.

The example method and system may also govern the application of any penalties (e.g., for missed deadlines) and may also factor the deadline penalty into any calculations and/or decisions about technician deployment, crew size, overtime, etc.

Although the present disclosure provides examples relating to the residential rental real estate sector, it should be understood that the present disclosure may also be applied in other renovation sectors.

Although the present disclosure makes reference to general contractors, it should be understood that this is an example. For example, the present disclosure may be applied to any other large organization with the ability to train and maintain the workforce required (e.g., a landlord or a management company with sufficient resources).

Although the present disclosure makes reference to a daily material and labor dispatch cycle, it should be understood that other dispatch cycles, both longer and shorter, are possible.

Although the present disclosure makes reference to using pictures as evidentiary materials, it should be understood that the collection of other appropriate evidentiary materials may be possible.

Although the present disclosure makes reference to handwritten signatures and encrypted PINs as evidence of authorization, it should be understood that any other suitable identity verification technique (e.g., fingerprinting, visual or auditory recording, secret phrases or passcodes, badges, keys or smartcards, among others) may be used for similar purposes.

Although the present disclosure makes reference to collection of property data related to floor, wall and other measurements, it should be understood that other types of measurements may be possible, and may also include collection of information relating to property attributes such as bath tub handedness, hinge side and swing direction on doors, light fixture types or appliances, among others. Any suitable method for collecting this data may be used including, for example, mechanical, electrical, electronic, direct (e.g., in-person inspection) or indirect (e.g., remote viewing of a property through cameras), among others. Any suitable method of verification of such data may be used.

The interface of the disclosed methods and systems may be any suitable interface including, for example, a graphical user interface, a text interface, an audio interface and combinations thereof.

In some examples, policies used in the disclosed methods and systems may take advantage of inherent patterns in property renovation. Such patterns may arise from a number of sources, including, for example, construction, management and location.

For example, where the property is in an apartment building, there may be a pattern to the layout of the property. Apartments are typically constructed with a small number of floor layouts (or plans), regardless of how tall they are, although the ground floor may be different (e.g., different exits, offices and other unique ground floor requirements), for status purposes, and sometimes the top floor is different. If present, the basement may be different. With such exceptions, most floors of an apartment building may have similar or identical layout. Such patterns may be driven by the need for certain building structures to be in the same place on every floor (e.g., load bearing columns and elevator shafts usually, in some cases plumbing, ventilation and electrical supplies also). There is typically an economic incentive to keep the same pattern for most if not all floors. Units in an apartment building may also exhibit minor symmetries (e.g., apartments 202 and 203 may be minor symmetric), in which the rooms have layouts that are mirrors of each other.

A policy may contain information about such patterns, such that input of the property's unit number may be sufficient to determine information (e.g., measurements, number of bedrooms and other such attributes) of the property. Such information may also be provided via the interface to an inspector, for example, to guide the inspector to look at particular features and to limit the selectable features for a renovation. The information about a unit might be known from a previous visit and inspection of that particular unit. Or it may be adduced from another unit using these pattern policies for the building.

Further, unit may be outfitted in similar or identical manner (e.g., for ease of management), such as having a single type and color of paint, bathroom light, kitchen light, faucet, and appliances. Even if there is not complete uniformity, there may be a very limited selection to choose from.

Such patterns may also be applicable for common areas (e.g., hallways, stairwells and elevator lobbies), such that, for example, the same wall covering, floor covering, lighting, may be used uniformly throughout the building.

Where the property is a townhouse, patterns may also be present. For example, there may be a certain small number of unit layouts replicated a number of times within a larger townhouse complex. Units may also be outfitted in similar or identical manner (e.g., same appliances, carpeting and paint) for management ease. The property database may contain information identifying the layout type of a property, rather than specifics of the property, and the appropriate policy may be called up in order to provide information about the specifics of the property, for example.

Where the property is a rental housing unit, such property typically may not be individually architect designed. This may give rise to useful pattern repetition, both in the property and the outfitting of it.

Where the property is an individual house, it may be that properties designed by the same architect may share similarities.

For example, the property database may be used to identify the unit type of a property to be renovated (e.g., the property database may explicitly state the unit type, or the property database may provide the location, such as suite number, of the property and the appropriate policy may be used to extrapolate the unit type), and the policy for this unit type may outline what kinds of renovations are suitable and which ones are not. This information may be used by the interface to present the property inspector with a limited number of renovation choices, thereby speeding up the inspection process. This information may also help to schedule (and budget) a suitable amount of inspection time (e.g., where renovation options are more limited, a shorter inspection may be sufficient). This information may also help to automatically verify some or all of the inspection information, for example where certain value ranges and/or selection options are limited for a unit type. For example, single bedroom apartments typically do not have 70 sq ft kitchens, so any such inspection data entered in the interface may be flagged as a possible error and the inspector may be prompted to correct this.

In some examples, policies used in the disclosed methods and systems may also account for patterns in time.

For example, where the property is an on-campus student housing, move-outs may tend to be around semester beginning and ending boundaries. Housing not specifically designed as student housing but in the area around a major school may also exhibit similar patterns related to the school year.

Other time patterns may include, for example, high and low work periods (e.g., lower renovation demands in winter vs. summer) and daily patterns (e.g., there is less disruption if common area work is done during evening hours). There may also be unique timelines that are taken into consideration by policies, such as a municipal or managerial requirement to replace appliances with newer more efficient ones by a certain time. Such patterns may be used by the disclosed methods and systems to determine the preferred time period for renovation work (e.g., during more economical times), and may help to predict manpower and inventory requirements at different times, for example.

Prediction of expected personnel, inventory and work needs at certain times may be used to generate a schedule for recruitment, training and for inventory management (e.g., to buy opportunistically and leverage projected purchases for price advantage).

Such patterns and predictions may be used in generation of the renovation schedule. For example, where there are multiple renovations required, they may be scheduled to take into account predicted workload and inventory fluctuations. For example, where there is a high/low workload pattern, the disclosed methods and systems may generate internal instructions to trigger planning for renovation work even before receipt of a moveout notice.

Where the disclosed methods and systems include a self-learning ability, patterns from past records may be identified and modeled to predict amounts of personnel and materials that will be needed at various future times, for example.

The disclosed methods and systems may allow for creation of a transaction log for full transactional transparency and accountability. The disclosed methods and systems may allow for tracking the status of renovation work, including the personnel responsible for a certain portion of the work and the timeliness of those personnel.

In some examples, the disclosed methods and systems may be implemented to achieve cost advantages. For example, in the private sector, tenants may move out, on average, about once every 18 months. Also on average, it may take about 45 days to turn over an apartment and have it re-rented. Between the move-out, renovation and move-in processes, there may be typically an 8% overhead (i.e., days when no rent is received for that unit). The disclosed methods and systems may help to reduce this vacancy loss by about 50% or more, in certain cases.

In the public housing sector, for example, tenants may typically stay longer, which may lead to more wear and tear on the property and thus longer renovation times. About 4 years may be considered an average tenancy in public housing. Typically, about 100 days is required to get an apartment ready to be re-leased. The disclosed methods and systems may help to reduce this renovation time to about ⅓ or less.

Such reductions in time may result in significant cost advantages. For example, in major markets in Canada, the rental rate, may range between about $25 (e.g., for a bachelor apartment in a high-rise) and about $50 (e.g., for a two bedroom apartment in a high-rise) per day. This may be higher for larger units or townhouses, for example.

The embodiments of the present disclosure described above are intended to be examples only. Alterations, modifications and variations to the disclosure may be made without departing from the intended scope of the present disclosure. In particular, selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

1. A method, carried out by one or more processors, for managing renovation of a property, the method comprising:
upon receiving signals representing instructions to carry out one or more renovation tasks for the property:
querying a policy database to determine at least one applicable policy based on the received instructions and identifying one or more renovation tasks based on at least one of the received instructions and the at least one applicable policy;
generating a schedule for the one or more renovation tasks, wherein generating the schedule comprises identifying at least one preferred time period for carrying out at least a portion of the one or more renovation tasks, based on the at least one policy, and prioritizing performance of at least the portion of the one or more renovation tasks during the preferred time period;
presenting an interface for updating status of completion of the one or more renovation tasks; and
generating a report of the one or more renovation tasks.

2. The method of claim 1 wherein the at least one applicable policy is determined based on at least one of: information identifying the property, information identifying the one or more renovation tasks and at least one other applicable policy.

3. The method of claim 1 wherein at least one of the one or more renovation tasks comprises a plurality of interrelated components, and at least one of the components is prioritized to be performed during the preferred time period over at least one other component.

4. The method of claim 3 wherein at least one of the components is restricted to be performed outside of the preferred time period.

5. The method of claim 1 wherein at least one of the one or more renovation tasks comprises at least one dependent component dependent on completion of at least one prerequisite component, and the at least one prerequisite component is prioritized in the schedule over the at least one dependent component.

6. The method of claim 1 further comprising:
determining at least one personnel for carrying out at least a portion of at least one renovation task, the determination being based on a query of a personnel database storing information about one or more personnel; and
updating the status of completion of the respective renovation task using information received, via the interface, from the at least one personnel.

7. The method of claim 6 further comprising:
detecting, using the information received from the at least one personnel, a deviation from the schedule;
generating a notification indicating the deviation; and
providing the generated notification to at least the same or another personnel via the interface.

8. The method of claim 6 further comprising:
detecting, using the information received from the at least one personnel, a deviation from the schedule; and
modifying the schedule to accommodate the deviation while maintaining the priority of any prioritized portions of the one or more renovation tasks.

9. The method of claim 1 wherein the preferred time period is at least one of: a period associate with lower activity in the property, a period associated with lower costs, a period associated with greater availability of personnel and a period associated with less inconvenience in the property.

10. The method of claim 1, further comprising generating one or more logs tracking completion of the one or more renovation tasks.

11. A system for managing renovation of a property, the system comprising:
a memory accessible by a processor, the memory comprising:
at least one policy database storing one or more predefined policies for carrying out renovation tasks;
the processor configured to implement a task management module, the task management module, when executed, causing the processor to:
upon receiving signals representing instructions to carry out one or more renovation tasks for the property:
query the policy database to determine at least one applicable policy based on the received instructions and identifying one or more renovation tasks based on at least one of the received instructions and the at least one applicable policy;
generate a schedule for the one or more renovation tasks, wherein generating the schedule comprises identifying at least one preferred time period for carrying out at least a portion of the one or more renovation tasks, based on the at least one policy, and prioritizing performance of at least the portion of the one or more renovation tasks during the preferred time period;
the processor configured to implement an interface module, the interface module, when executed, causing the processor to:
provide as output the generated schedule;
present an interface for receiving status updates of completion of the one or more renovation tasks; and
provide as output a generated report of the one or more renovation tasks.

12. The system of claim 11 wherein the memory further comprises at least one of:
a property database storing information about one or more properties available for renovation;
a personnel database storing information about one or more personnel for performing the one or more renovation tasks;
a report database storing one or more generated reports; and
a deviation database storing information about one or more deviations from any generated schedule.

13. The system of claim 11 wherein the task management module further causes the processor to automatically update at least one policy stored in the policy database based on historical data.

14. The system of claim 11 wherein at least one of the interface and the output is accessible by an external device.

15. The system of claim 14 wherein the external device is one of: a desktop device, a handheld device, a tablet device, a wired device and a wireless device.
